(19) United States
(12) Patent Application Publication
(10) Pub. No.: US 2026/0211988 A1
(43) Pub. Date: Jul. 23, 2026

(54) SYSTEMS AND METHODS FOR SIMULATING POINTING DEVICE WITH FINGERPRINT READER SENSOR

(71) Applicant: Dell Products L.P., Round Rock, TX (US)

(72) Inventors: Chin-Yuan CHIANG, New Taipei City (TW); Jen-Hao CHENG, Taipei City (TW); Shih-Chang HU, New Taipei City (TW)

(73) Assignee: Dell Products L.P., Round Rock, TX (US)

(21) Appl. No.: 19/035,105

(22) Filed: Jan. 23, 2025

(51) Int. Cl. G06F 21/32

(52) U.S. Cl. CPC G06F 21/32

(57) ABSTRACT

A method may include receiving fingerprint image data from a fingerprint reader sensor integrated within a keyboard of an information handling system, in an authentication condition of the information handling system, processing the fingerprint image data to authenticate a user of the information handling system in an enrollment condition of the information handling system, processing the fingerprint image data to enroll a user fingerprint for use in authentication, and in a condition of the information handling system other than the authentication condition and the enrollment condition, processing the fingerprint image data to monitor movement of a finger about the fingerprint reader sensor and translate the movement of the finger into movement of a pointer about a display device of the information handling system.

### TECHNICAL FIELD

The present disclosure relates in general to information handling systems, and more particularly to simulating a pointing device with a fingerprint reader sensor.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often include keyboards. A keyboard may comprise any suitable system, device, or apparatus modeled after a typewriter keyboard or other keyboard which uses an arrangement of buttons or keys to act as mechanical levers or electronic switches for inputting data to an information handling system.

Many keyboards include an integrated trackpoint, which may also be referred to as a pointing stick. A trackpoint may be a small analog stick used as a pointing device and is typically mounted centrally in a keyboard. Like other pointing devices such as mice, touchpads or trackballs, operating system software of an information handling system may translate manipulation of the trackpoint into movements of the pointer on a display device of the information handling system.

Increasingly, information handling systems include biometric input devices, for example fingerprint reader sensors, for use in authenticating users. However, inclusion of a fingerprint reader sensor and a trackpoint (or other pointing device, such as a touchpad) on a keyboard may take up significant space on a keyboard, and add cost to construction of the keyboard.

### SUMMARY

In accordance with the teachings of the present disclosure, the disadvantages and problems associated with traditional approaches to inclusion of input devices on a keyboard may be reduced or eliminated.

In accordance with embodiments of the present disclosure, an information handling system may include a processor, a keyboard including a fingerprint reader sensor integrated within the keyboard, and a fingerprint reader agent comprising a program of instructions embodied in non-transitory computer-readable media communicatively coupled to the processor and configured to, when read and executed by the processor, receive fingerprint image data from the fingerprint reader sensor, in an authentication condition of the information handling system, process the fingerprint image data to authenticate a user of the information handling system, in an enrollment condition of the information handling system, process the fingerprint image data to enroll a user fingerprint for use in authentication, and in a condition of the information handling system other than the authentication condition and the enrollment condition, process the fingerprint image data to monitor movement of a finger about the fingerprint reader sensor and translate the movement of the finger into movement of a pointer about a display device of the information handling system.

In accordance with these and other embodiments of the present disclosure, a method may include receiving fingerprint image data from a fingerprint reader sensor integrated within a keyboard of an information handling system, in an authentication condition of the information handling system, processing the fingerprint image data to authenticate a user of the information handling system in an enrollment condition of the information handling system, processing the fingerprint image data to enroll a user fingerprint for use in authentication, and in a condition of the information handling system other than the authentication condition and the enrollment condition, processing the fingerprint image data to monitor movement of a finger about the fingerprint reader sensor and translate the movement of the finger into movement of a pointer about a display device of the information handling system.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to receive fingerprint image data from a fingerprint reader sensor integrated within a keyboard of an information handling system, in an authentication condition of the information handling system, process the fingerprint image data to authenticate a user of the information handling system, in an enrollment condition of the information handling system, process the fingerprint image data to enroll a user fingerprint for use in authentication, and in a condition of the information handling system other than the authentication condition and the enrollment condition, process the fingerprint image data to monitor movement of a finger about the fingerprint reader sensor and translate the movement of the finger into movement of a pointer about a display device of the information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure; and

FIG. 2 illustrates a flow chart of an example method for simulating a pointing device with a fingerprint reader sensor, in accordance with embodiments of the present disclosure.

### DETAILED DESCRIPTION

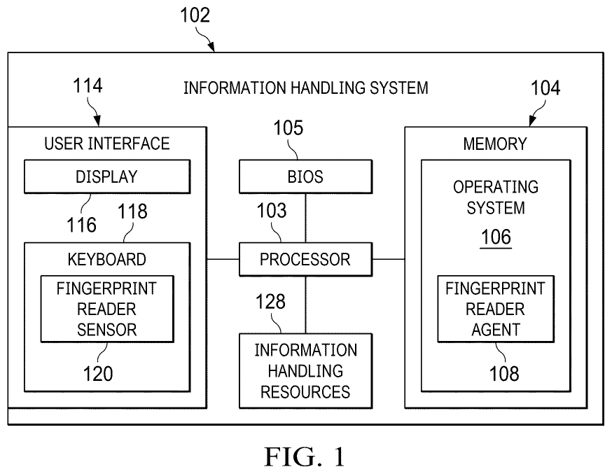

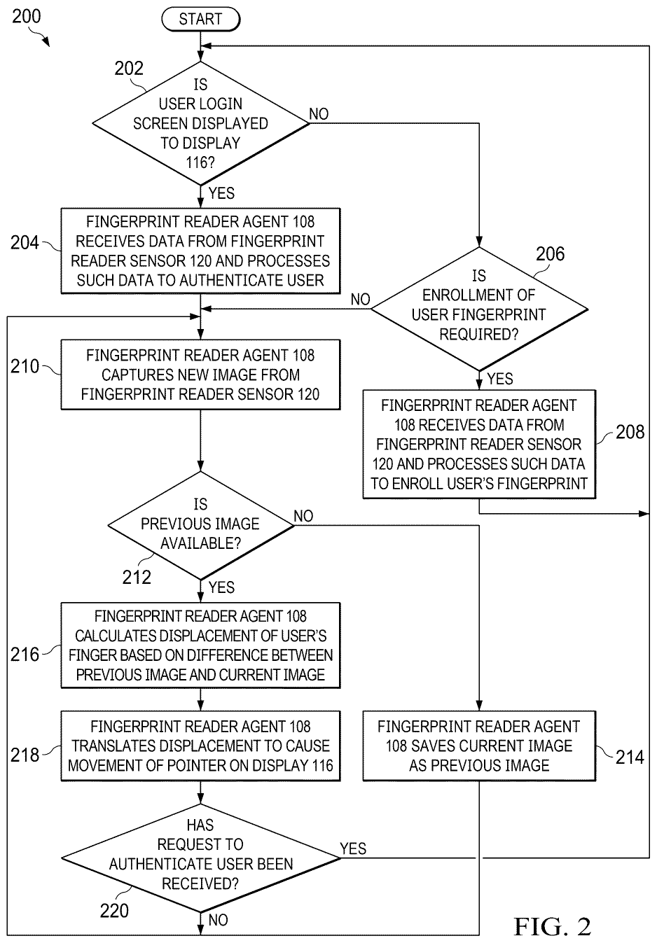

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

FIG. 1 illustrates a block diagram of selected components of an example information handling system 102, in accordance with embodiments of the present disclosure. In some embodiments, information handling system 102 may comprise or be an integral part of a server. In some embodiments, information handling system 102 may be a personal computer (e.g., a desktop computer or a portable computer). In other embodiments, information handling system 102 may comprise a mobile device (e.g., a smart phone, a tablet computing device, a handheld computing device, a personal digital assistant, or any other device that may be readily transported on a person of a user of such mobile device).

As depicted in FIG. 1, information handling system 102 may include a processor 103, a memory 104 communicatively coupled to processor 103, a user interface 114 communicatively coupled to processor 103, and one or more information handling resources 128 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, and/or another component of information handling system 102.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated information handling system 102 is turned off.

As shown in FIG. 1, memory 104 may have stored therein an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

As also shown in FIG. 1, operating system 106 may include a fingerprint reader agent 108. Fingerprint reader agent 108 may comprise one or more programs of instructions, which may run on operating system 106 as an application program, driver, or utility, and may be configured to read data from a fingerprint reader sensor (e.g., fingerprint reader sensor 120) and process such data. As described in greater detail below, fingerprint reader agent 108 may be configured to, in the condition of enrollment or authentication of a user, use data from a fingerprint reader sensor for purposes of enrollment or authentication of a user. Fingerprint reader agent 108 may further be configured to, in other conditions, use data from the fingerprint reader sensor to monitor movement of a fingerprint about the fingerprint reader sensor, and translate such movement into movements of a pointer (e.g., arrow, cursor, etc.) on a display device (e.g., display 116) of information handling system 102. Accordingly, fingerprint reader agent 108 may enable the fingerprint reader sensor to, when not used for enrollment or authentication, simulate a trackpoint, touchpad, or other pointing device, translating user manipulation of the fingerprint reader into movements of a pointer on a display.

A BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105.

User interface 114 may comprise any instrumentality or aggregation of instrumentalities by which a user may interact with information handling system 102. For example, user interface 114 may permit a user to input data and/or instructions into information handling system 102 (e.g., via a pointing device, keypad, keyboard, touch screen, microphone, camera, and/or other data input device), and/or otherwise manipulate information handling system 102 and its associated components. User interface 114 may also permit information handling system 102 to communicate data to a user (e.g., via a display device, speaker, and/or other data output device). As shown in FIG. 1, user interface 114 may include one or more of a display 116 and a keyboard 118.

Display 116 may comprise any suitable system, device, or apparatus configured to display human-perceptible graphical data and/or alphanumeric data to a user. For example, in some embodiments, display 116 may comprise a liquid crystal display.

Keyboard 118 may comprise any suitable system, device, or apparatus modeled after a typewriter keyboard or other keyboard which uses an arrangement of buttons or keys to act as mechanical levers or electronic switches for inputting data to information handling system 102.

As shown in FIG. 1, keyboard 118 may have a fingerprint reader sensor 120 integrated within. Fingerprint reader sensor 120 may include any system, device, or apparatus configured to obtain an image of a person's fingerprint, and communicate data representative of the fingerprint image to processor 103. For example, in some embodiments, fingerprint reader sensor 120 may include a capacitive scanner that uses electrical capacitors (and thus electric current) to form an image of a fingerprint. However, in other embodiments fingerprint reader sensor 120 may include an optical scanner that captures a visual image of a fingerprint using a digital camera, an ultrasonic fingerprint scanner that uses high-frequency sound waves to penetrate the epidermal (outer) layer of the user's skin, or a thermal scanner that senses the temperature differences on the contact surface, in between fingerprint ridges and valleys. In these and other embodiments, fingerprint reader sensor 120 may be integrated within a button or key (e.g., the “H” key) of keyboard 118.

In addition to processor 103, memory 104, BIOS 105, and user interface 114, information handling system 102 may include one or more other information handling resources 128. Such an information handling resource 128 may include any component system, device or apparatus of an information handling system, including without limitation, a processor, bus, memory, I/O device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

FIG. 2 illustrates a flow chart of an example method 200 for simulating a pointing device with a fingerprint reader sensor, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, fingerprint reader agent 108 may determine if operating system 106 is displaying a user login screen to display 116. If the user login screen is being displayed, method 200 may proceed to step 204. Otherwise, method 200 may proceed to step 206.

At step 204, fingerprint reader agent 108 may receive data from fingerprint reader sensor 120 and process such data to authenticate a user. After completion of step 204, method 200 may proceed to step 210.

At step 206, fingerprint reader agent 108 may determine if a user's fingerprint needs to be enrolled. If a user's fingerprint needs to be enrolled, method 200 may proceed to step 208. Otherwise, method 200 may proceed to step 210.

At step 208, fingerprint reader agent 108 may receive data from fingerprint reader sensor 120 and process such data to enroll a user's fingerprint. After completion of step 204, method 200 may proceed again to step 202.

At step 210, fingerprint reader agent 108 may transition to a pointing device mode, in which it processes data from fingerprint reader sensor 120 and processes such data to monitor a user's movement of the user's finger about fingerprint reader sensor 120, and translates such movement into movement of a pointer about display 116. Such pointing device mode may begin at step 210 with fingerprint reader agent 108 capturing a new image from fingerprint reader sensor 120.

At step 212, fingerprint reader agent 108 may determine whether a previous image is available. If a previous image is available, method 200 may proceed to step 216. Otherwise, method 200 may proceed to step 214.

At step 214, fingerprint reader agent 108 may save the current image as the previous image. After step 214, method 200 may proceed again to step 210.

At step 216, fingerprint reader agent 108 may calculate a displacement of a user's finger based on a difference between the previous image and the current image.

At step 218, fingerprint reader agent 108 may translate the displacement to cause movement of a pointer on display 116. For example, the calculated displacement may be converted to a Universal Serial Bus (USB) Human Interface Device (HID) packet and reported to a Picture Transfer Protocol (PTP).

At step 220, fingerprint reader agent 108 may determine if a request (e.g., a Windows Biometric or WinBio) to authenticate a user has been received. If a request to authenticate a user has been received, method 200 may proceed again to step 202, in which fingerprint reader agent 108 may leave the pointing device mode and switch back to a fingerprint reader mode. Otherwise, method 200 may proceed again to step 210.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using a variety of configurations of information handling system 102 and/or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor;
a keyboard including a fingerprint reader sensor integrated within the keyboard; and
a fingerprint reader agent comprising a program of instructions embodied in non-transitory computer-readable media communicatively coupled to the processor and configured to, when read and executed by the processor:
receive fingerprint image data from the fingerprint reader sensor;
in an authentication condition of the information handling system, process the fingerprint image data to authenticate a user of the information handling system;
in an enrollment condition of the information handling system, process the fingerprint image data to enroll a user fingerprint for use in authentication; and
in a condition of the information handling system other than the authentication condition and the enrollment condition, process the fingerprint image data to monitor movement of a finger about the fingerprint reader sensor and translate the movement of the finger into movement of a pointer about a display device of the information handling system.

2. The information handling system of claim 1, wherein:
processing the fingerprint image data comprises calculating a displacement of the finger based on a difference between a first fingerprint image of the fingerprint image data and a second fingerprint image of the fingerprint image data; and
translating the movement of the finger into movement of the pointer comprises translating the displacement into movement of the pointer.

3. The information handling system of claim 1, wherein the fingerprint reader sensor comprises a capacitive scanner.

4. The information handling system of claim 1, wherein the fingerprint reader sensor in integrated within a key of the keyboard.

5. A method comprising:
receiving fingerprint image data from a fingerprint reader sensor integrated within a keyboard of an information handling system;
in an authentication condition of the information handling system, processing the fingerprint image data to authenticate a user of the information handling system;
in an enrollment condition of the information handling system, processing the fingerprint image data to enroll a user fingerprint for use in authentication; and
in a condition of the information handling system other than the authentication condition and the enrollment condition, processing the fingerprint image data to monitor movement of a finger about the fingerprint reader sensor and translate the movement of the finger into movement of a pointer about a display device of the information handling system.

6. The method of claim 5, wherein:
processing the fingerprint image data comprises calculating a displacement of the finger based on a difference between a first fingerprint image of the fingerprint image data and a second fingerprint image of the fingerprint image data; and
translating the movement of the finger into movement of the pointer comprises translating the displacement into movement of the pointer.

7. The method of claim 5, wherein the fingerprint reader sensor comprises a capacitive scanner.

8. The method of claim 5, wherein the fingerprint reader sensor in integrated within a key of the keyboard.

9. An article of manufacture comprising:
a non-transitory computer-readable medium; and
computer-executable instructions carried on the computer-readable medium, the instructions readable by a processor, the instructions, when read and executed, for causing the processor to:
receive fingerprint image data from a fingerprint reader sensor integrated within a keyboard of an information handling system;
in an authentication condition of the information handling system, process the fingerprint image data to authenticate a user of the information handling system;
in an enrollment condition of the information handling system, process the fingerprint image data to enroll a user fingerprint for use in authentication; and
in a condition of the information handling system other than the authentication condition and the enrollment condition, process the fingerprint image data to monitor movement of a finger about the fingerprint reader sensor and translate the movement of the finger into movement of a pointer about a display device of the information handling system.

10. The article of claim 9, wherein:
processing the fingerprint image data comprises calculating a displacement of the finger based on a difference between a first fingerprint image of the fingerprint image data and a second fingerprint image of the fingerprint image data; and
translating the movement of the finger into movement of the pointer comprises translating the displacement into movement of the pointer.

11. The article of claim 9, wherein the fingerprint reader sensor comprises a capacitive scanner.

12. The article of claim 9, wherein the fingerprint reader sensor in integrated within a key of the keyboard.
